(19) United States
(12) Patent Application Publication
(10) Pub. No.: US 2016/0091148 A1
(43) Pub. Date: Mar. 31, 2016

(54) SOLID-STATE LIGHTING APPARATUS WITH DETACHABLE MODULE

(71) Applicant: HUIZHOU LIGHT ENGINE LIMITED, HUIZHOU (CN)

(72) Inventors: Wa Hing Leung, Hong Kong (CN); Tin Po Flavio Chu, Hong Kong (CN); Chun Sing Chow, Hong Kong (CN)

(73) Assignee: HUIZHOU LIGHT ENGINE LIMITED, HUIZHOU (CN)

(21) Appl. No.: 14/865,500

(22) Filed: Sep. 25, 2015

Related U.S. Application Data
(60) Provisional application No. 62/055,105, filed on Sep. 25, 2014.

(51) Int. Cl. F21K 99/00; F21V 23/02; F21V 23/00

(52) U.S. Cl. CPC F21K 9/17; F21V 23/006; F21V 23/02; F21Y 2103/003

(57) ABSTRACT

In a solid-state lighting apparatus, a lamp body is provided with a solid-state light module and a detachable module space in the lamp body. A detachable module is provided exterior to the lamp body prior to insertion and which is insertable into the detachable module space and has contacts engageable with corresponding contacts in the module space. The detachable module has an internal circuit for controlling the solid-state light module.

### CROSS-REFERENCE TO RELATED APPLICATIONS

This application claims the benefit and priority to U.S. Ser. No. 62/055,105, filed Sep. 25, 2014, the entirety of which is incorporated herein by reference.

### BACKGROUND OF THE INVENTION

Four prong solid-state lighting tubes (with two prongs at each end) are known which are received in fluorescent tube fixtures and are a direct retrofit replacement for the known four prong fluorescent tubes. These known solid-state lighting retrofit tubes are supplied with AC power as is also known from a ballast transformer. It is known to convert this AC power to DC by an AC to DC power supply to create DC power for the retrofit solid-state lighting tube. Both the fluorescent and solid-state lighting tubes may be turned on or off by switching the AC power feed to or from the ballast on or off.

Alternatively, some fluorescent tube fixtures feed 120-230 VAC for the fluorescent tube. In this case, the retrofit solid-state lighting tube is fed from an AC to DC power supply.

It is also known to provide DC powered DC fluorescent tubes from a DC source and retrofit solid-state lighting tubes are also known as a direct replacement in a fixture supplying DC for the DC fluorescent tubes. In this case a known DC power supply is provided to create the appropriate DC power for the retrofit solid-state lighting tubes.

Solid-state lighting lamps are also known which are not tube-shaped but rather have flat faces, are semi-spherical, or have other shapes.

### SUMMARY OF THE INVENTION

It is an object to provide a solid-state lighting retrofit lamp body receivable in a fluorescent fixture but which is controllable by a module.

In a solid-state lighting apparatus, a lamp body is provided with a solid-state light module and a detachable module space in the lamp body. A detachable module is provided exterior to the lamp body prior to insertion and which is insertable into the detachable module space and has contacts engageable with corresponding contacts in the module space. The detachable module has an internal circuit for controlling the solid-state light module. The lamp body functions with or without the detachable module.

In an aspect of the present invention, a solid-state lighting apparatus, comprising a lamp body with a solid-state light module and a detachable module space in said lamp body; a detachable module exterior to said lamp body prior to insertion and insertable into said detachable module space and having contacts engageable with corresponding contacts in said module space; and said detachable module having an internal circuit for controlling said solid-state light module.

In a further aspect of the present invention, said lamp body has a power supply unit integrated therein and connectible to the detachable module in said detachable module space.

In a further aspect of the present invention, an interchangeable platform is provided and comprises said power supply unit, said power supply unit having said corresponding contacts which are engageable with said contacts of said detachable module.

In a further aspect of the present invention, said power supply unit has an internal circuit receiving electrical power based on an electrical supply to said lamp body and which supplies power to said light module.

In a further aspect of the present invention, said lamp body with said solid-state light module is a retrofit for a fluorescent lamp body and is receivable as said retrofit in a fluorescent lamp fixture for receiving said fluorescent lamp body.

In a further aspect of the present invention, said lamp body is tubular-shaped and has two prongs at one end and two prongs at an opposite end, said prongs being arranged so that said lamp body is said retrofit for said fluorescent lamp body received in said fluorescent lamp fixture.

In a further aspect of the present invention, wherein said lamp body functioning with or without said detachable module.

In a further aspect of the present invention, said detachable module performs at least one of the functions of wireless communication, optical communication, actuation of the light module, sensor activation of the light module, activation of the light module based on received light, control of the light module based on motion detection, control of the light module based on smoke detection, control of the light module based on temperature detection, control of the light module based on received sound, and control of the light module based on user activation.

In a further aspect of the present invention, said contacts of the detachable module and the corresponding contacts at said module space comprise at least one contact for voltage and another contact for a control signal.

In a further aspect of the present invention, a second contact is provided for voltage.

In a further aspect of the present invention, first and second detachable module spaces are provided for receiving the detachable module or a further detachable module.

In a further aspect of the present invention, a further detachable module is provided and wherein the detachable module is receivable in a first detachable module space and the second detachable module is received in a second detachable module space.

In a further aspect of the present invention, said lamp body is shaped as a tube and said detachable module space is at one end of said tube.

In a further aspect of the present invention, said detachable module has additional contacts, and an additional detachable module is provided having contacts engageable with said additional contacts of said detachable module.

In a further aspect of the present invention, said additional detachable module comprises a sensor module having a sensor.

In a further aspect of the present invention, said additional detachable module comprises an indication module.

In a further aspect of the present invention, said lamp body comprises a partially spherical bulb.

In a further aspect of the present invention, said lamp body comprises a body with parallel flat sides and light emitting from one of said sides.

In a further aspect of the present invention, said lamp body is tubular and has a curved optical portion and a curved opaque portion opposite the optical portion and wherein an LED printed circuit board assembly is provided with LEDs on one surface positioned to radiate light through said optical portion.

In another aspect of the present invention, a solid-state lighting apparatus, comprising a lamp body with a solid-state light module and a detachable module space in said lamp body; a detachable module exterior to said lamp body prior to insertion and insertable into said detachable module space and having contacts engageable with corresponding contacts in said module space; said detachable module having an internal circuit for controlling said solid-state light module; and an additional detachable module connectible to said detachable module.

In a further aspect of the present invention, wherein said lamp body functioning with or without said detachable module.

In another aspect of the present invention, a solid-state lighting apparatus, comprising a lamp body with a solid-state light module and a detachable module space in said lamp body; a detachable module exterior to said lamp body prior to insertion and insertable into said detachable module space and having contacts engageable with corresponding contacts in said module space; said detachable module having an internal circuit for controlling said solid-state light module;and said lamp body being a retrofit for a fluorescent light module and receivable as said retrofit into a fixture for receiving said fluorescent light module.

In a further aspect of the present invention, wherein said lamp body functioning with or without said detachable module.

### BRIEF DESCRIPTION OF THE DRAWINGS

The figures are for illustration purposes only and are not necessarily drawn to scale. The invention itself, however, may best be understood by reference to the detailed description which follows when taken in conjunction with the accompanying drawings in which:

FIG. 1 is a perspective view showing a retrofit solid-state lighting tube having a detachable module separated from one end of the tube and another detachable module inserted at an opposite end of the tube;

FIG. 2 is a perspective view of the tube of FIG. 1 but with the detachable module at the left one end inserted into the tube;

FIG. 3 is a cross-sectional view taken along section line numeral III-III in FIG. 2;

FIG. 4 is an exploded perspective view of an interchangeable platform with a power supply unit adjacent a detachable module space in the lighting tube;

FIG. 5 is a bottom view of a printed circuit board assembly with LEDs thereon which is adjacent the interchangeable platform;

FIG. 6 is an exploded view of the detachable module shown in FIG. 1;

FIG. 7 is a perspective view of an additional detachable module which may be connected to the detachable module;

FIG. 8 is a perspective view with the additional detachable module of FIG. 7 connected to the detachable module;

FIG. 9 is an exploded perspective view of the additional detachable module designed as a sensor module;

FIG. 10 is diagram illustrating various configurations of the attachable module and the additional detachable module designed as a sensor module;

FIG. 11 is a schematic diagram showing the power supply unit and connections thereto for accommodating one detachable module;

FIG. 12 is a schematic diagram showing the power supply unit and connections thereto for accommodating two detachable modules;

FIG. 13 is a schematic diagram showing connection contacts for the detachable module received in the detachable module space of FIG. 12;

FIG. 14 is a schematic diagram showing connection contacts for the additional detachable module designed as a sensor module and connectible to the detachable module;

FIG. 15 is a schematic diagram of the additional detachable module designed as an indication module and connectible to the detachable module;

FIG. 16 is a diagram illustrating an alternate embodiment for the detachable module and the additional detachable module designed as a sensor module in various configurations;

FIG. 17A illustrates use of the solid-state lighting apparatus with a detachable module and also with an additional detachable sensor module of the second embodiment type shown in FIG. 16 with no person in a room, FIG. 17B illustrates the room occupied by a person at a left side of the room, and FIG. 17C illustrates the room occupied by a person at the right side of the room;

FIGS. 18A, 18B, and 18C are alternate embodiments of the solid-state lighting apparatus with detachable module using a semi-spherical solid-state lighting bulb: and

FIGS. 19A, 19B, and 19C are alternate embodiments of the solid-state lighting apparatus with detachable module as a solid-state lighting lamp body for radiating downlight.

### DETAILED DESCRIPTION OF EXEMPLARY EMBODIMENTS

For the purposes of promoting an understanding of the principles of the invention, reference will now be made to preferred exemplary embodiments/best mode illustrated in the drawings and specific language will be used to describe the same. It will nevertheless be understood that no limitation of the scope of the invention is thereby intended, and such alterations and further modifications in the illustrated embodiments and such further applications of the principles of the invention as illustrated as would normally occur to one skilled in the art to which the invention relates are included herein.

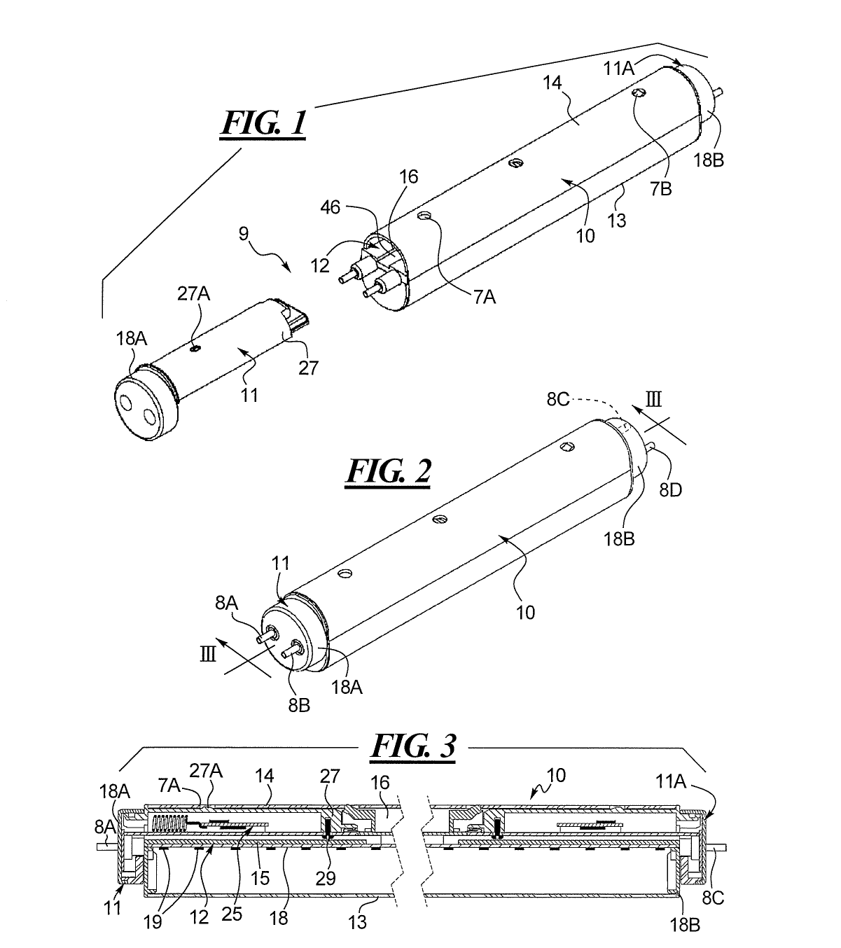

In the perspective illustration of FIG. 1 the solid-state lighting apparatus with detachable module is generally illustrated at 9 and comprises a solid-state lighting lamp body 10 and a detachable module 11 shown separated from one end of the lamp body 10 and, if desired, another detachable module 11A inserted into an opposite end of the lamp body 10.

The lamp body 10 comprises an interchangeable platform 12 to receive the detachable module 11. With the detachable modules 11 and 11A removed the lamp body 10 will function as a normal solid-state lighting apparatus. The detachable module 11 (or 11A if the detachable module is provided) provides additional functions including for example wireless or optical communication, control, sensor, light, actuation, etc . . . to the lamp body 10. The user can choose a suitable detachable module 11 and plug it into the lamp body 10.

The tube 10 is a solid-state lighting (“SSL” hereafter) tube which is a retrofit to replace a known fluorescent tube received in the known fluorescent tube fixture. The detachable module 11 plugs into the lamp body 10 and provides add-on functions to the retrofit SSL tube 10. The detachable module 11 is interchangeable with different sizes and functions which include but is not limited to communication (RF wireless, light wireless, send and receive signals), control (control another device via a wireless signal), detection (light, motion, smoke, temperature, and vibration), signal/alarm/media (sound, light, and vibration), light (indicator, spot light) and/or actuation (cooling fan, safety lock, etc.).

FIG. 2 shows the detachable module 11 in its inserted condition within the lamp body 10. End cap 18A is provided at one end of the lamp body 10 and end cap 18B is provided on an end of the detachable module 11.

FIG. 3 shows a cross-section taken along line III-III in FIG. 2 of the lamp body 10 with the detachable module 11 inserted therein.

The lamp body described herein will function with or without the detachable module inserted.

As shown in FIG. 2, the retrofit SSL tube as the lamp body 10 has 4 prongs 8A, 8B, 8C, and 8D received in the known fluorescent tube lighting fixture when replacing a fluorescent tube.

In the cross-sectional view of FIG. 3 one may observe the interchangeable platform 12 receiving the detachable module 11 and located at a floor of a detachable module space 16. This interchangeable platform 12 with its associated power supply 17 is integrated in the lamp body 10. Note that the lamp body 10 as illustrated in both FIG. 1 and FIG. 3 is a bi-color tube with an optical portion 13 and an opaque portion 14. The detachable module 11 is received in the detachable module space 16 formed between the interchangeable platform 12 and the opaque portion 14. The opaque portion 14 has apertures 7A and 7B which are respective snap hook holes for engaging with a snap hook 27A when the detachable module 11 is inserted into the lamp body 10 at either end of the lamp body.

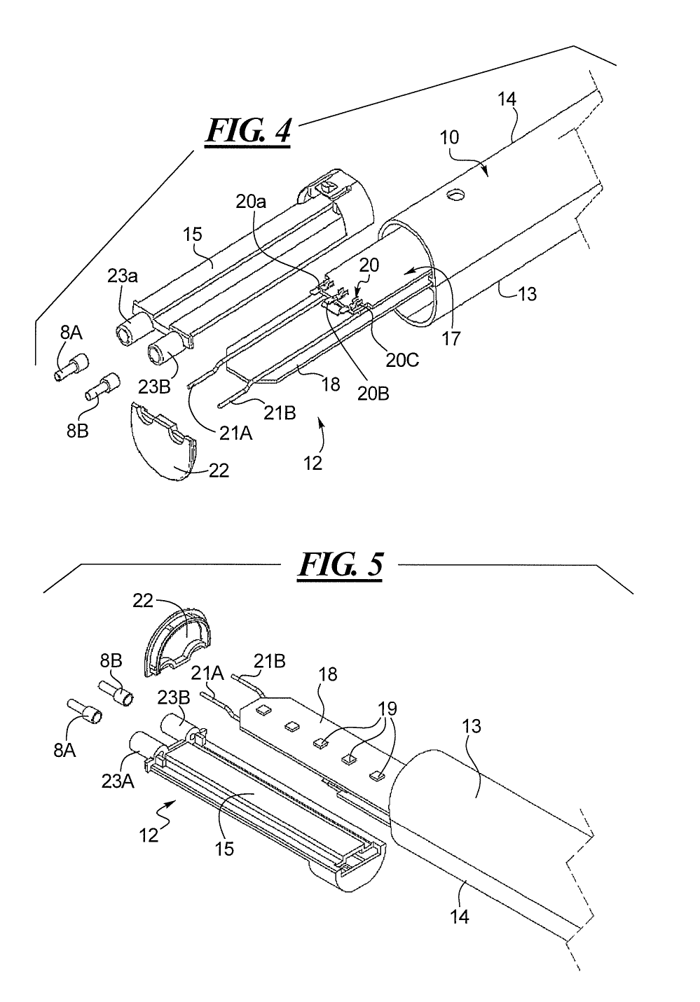

The interchangeable unit 12 comprises a power supply unit 17 (FIG. 4) located on an LED PCB assembly 18 having a plurality of LEDs 19 as shown in the bottom perspective view of FIG. 5 (FIG. 4 being a top perspective view). A contact member unit 20 is provided on the power supply unit 17. Prongs 8A, 8B are connected to wires 21A, 21B. An optical portion end cover 22 and respective sleeves 23A, 23B are also provided surrounding respective wires 21A, 21B.

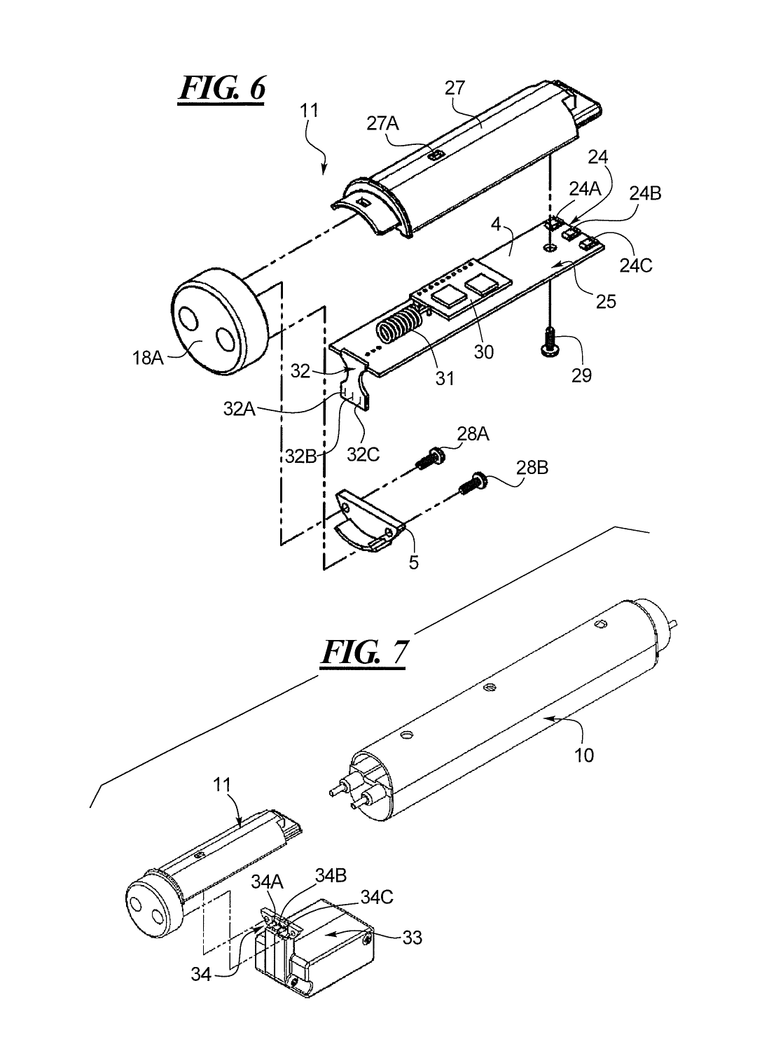

The lamp body 10 may have not only one detachable module space 16 but may have another detachable module space 16A (FIG. 12) at the opposite end of the lamp body 10. A platform cover 15 is used to protect internal circuitry to avoid electrical shock of the user. The interchangeable platform 12 with the power supply unit 17 is placed inside the lamp body or tube 10 and the contact member unit 20 comprises three separate contact members 20A, 20B, and 20C used to make connection to respective contact members 24A, 24B, 24C shown in FIG. 6 at an end of a wireless module printed circuit board assembly 25 also shown in FIG. 6 which illustrates in perspective the detachable module 11 in an exploded view.

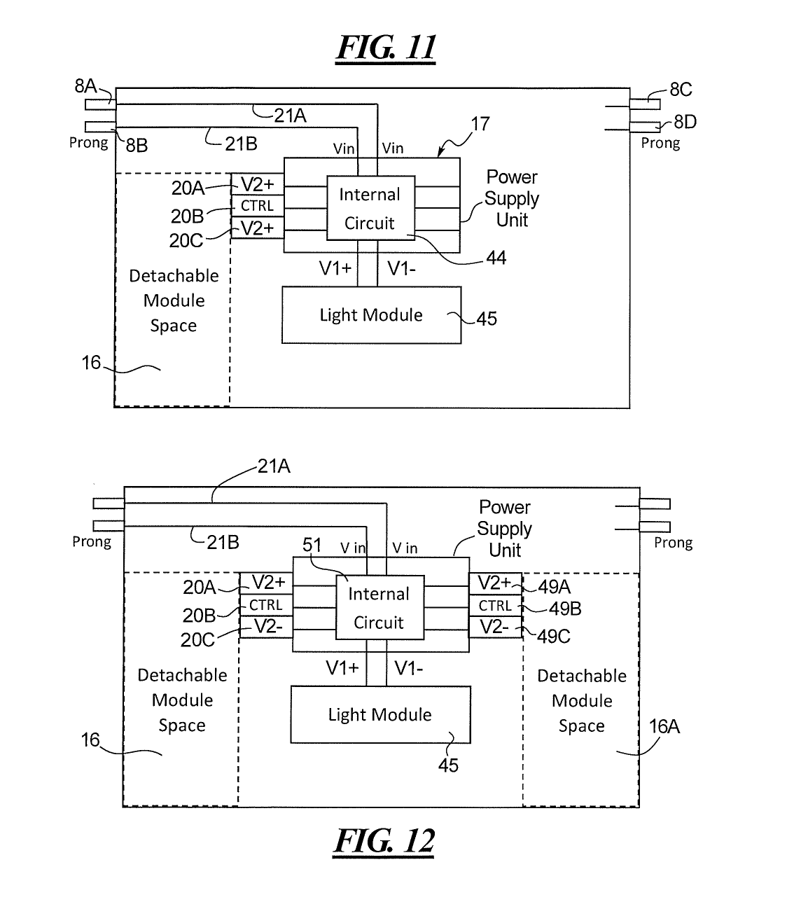

As mentioned previously, as shown in FIG. 5 the LED PCB assembly 18 has a plurality of LEDs 19 sending light through the optical portion 13. The prongs 8A and 8B are connected to the power supply unit 17 by respective wires 21A, 21B covered by the platform cover 15. These wires 21A, 21B connected to respective prongs 8A and 8B are also shown hereafter in FIG. 11.

As shown in the exploded view of FIG. 6, the detachable module 11 comprises the end cap 18A, and a detachable module cover 27 having the snap hook 27A. An end cover 5 is retained by screws 28A, 28B to the end cap 18A. The PCB assembly 25 is mounted to cover 27 by screw 29 and comprises a wireless module 30, an antenna 31, a contact member assembly 24 with individual contact members 24A, 24B, and 24C, and a printed circuit connection board 4. As previously mentioned, the contact members 24A, 24B, 24C connect to the contact members 20A, 20B, and 20C on the power supply unit 17.

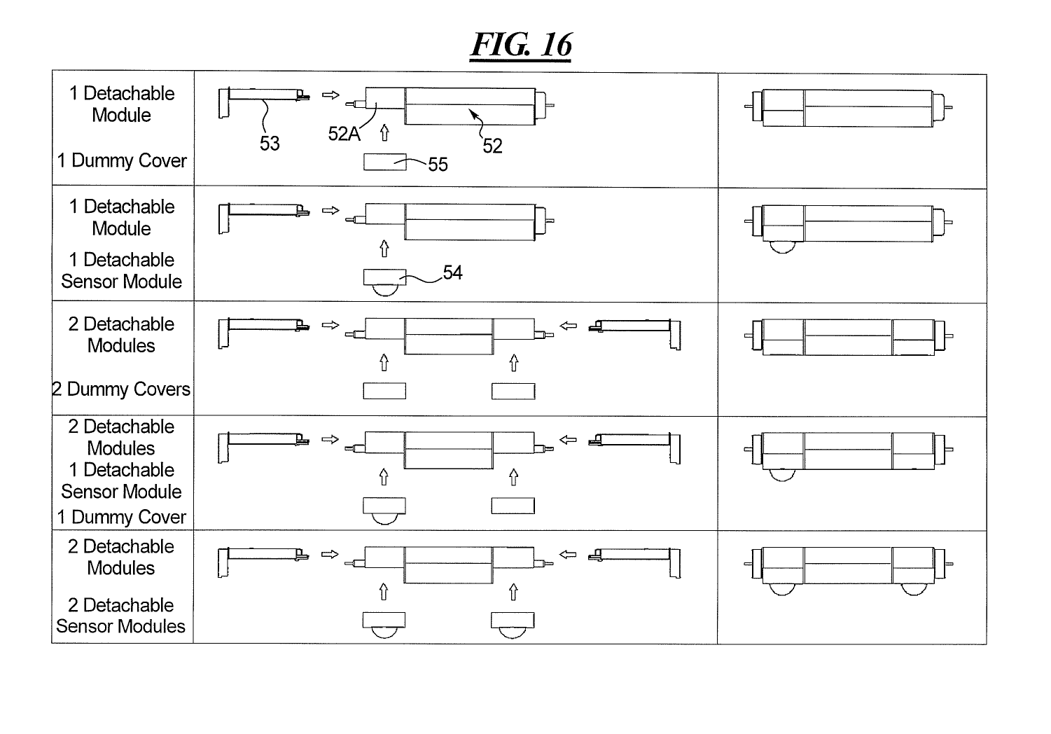

A connection board 32 shown in FIG. 6 on the PC board 25 and having contact members 32A, 32B, 32C is used for connecting to an additional detachable module 33 as shown in FIG. 7. This additional detachable module 33 can either be a sensor module having connections shown at 33B in FIG. 14 or an indication module having connections shown at 33A in FIG. 15. A connection board 34 is provided on one end of the additional detachable module 33 and has respective contact members 34A, 34B, and 34C which mate with the respective contact members 32A, 32B, 32C on the wireless module PCB assembly 25 on the connection board 32 of the detachable module 11.

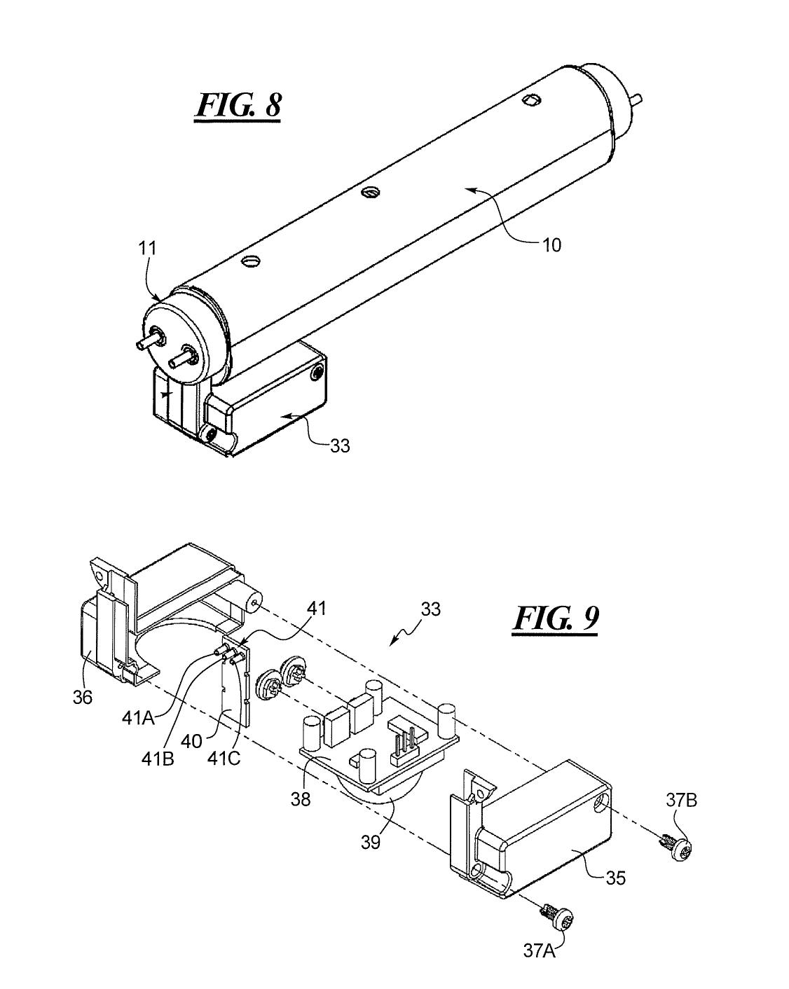

As shown in FIG. 8 the additional detachable module 33 is shown attached to the detachable module 11.

The additional detachable module 33 can be, for example, a sensor, an indicator, an actuator . . . etc. This additional detachable module 33 may acquire surrounding environment information, for example.

As shown in FIG. 9, the additional detachable module 33 may have first and second detachable housing parts 35 and 36 attached together by screws 37A, 37B.

Within the housing parts a printed circuit board (PCB) assembly 38 is located connecting to a downwardly facing sensor 39 if the additional detachable module 33 has the connections shown in FIG. 14 at 33B with the internal circuit 42 on the PCB board 38. Alternatively as previously mentioned the additional detachable housing 33 may function as an indication module and would have the connections shown in FIG. 15 at 33A with an internal circuit 43 and contact members 41A, 41B, 41C.

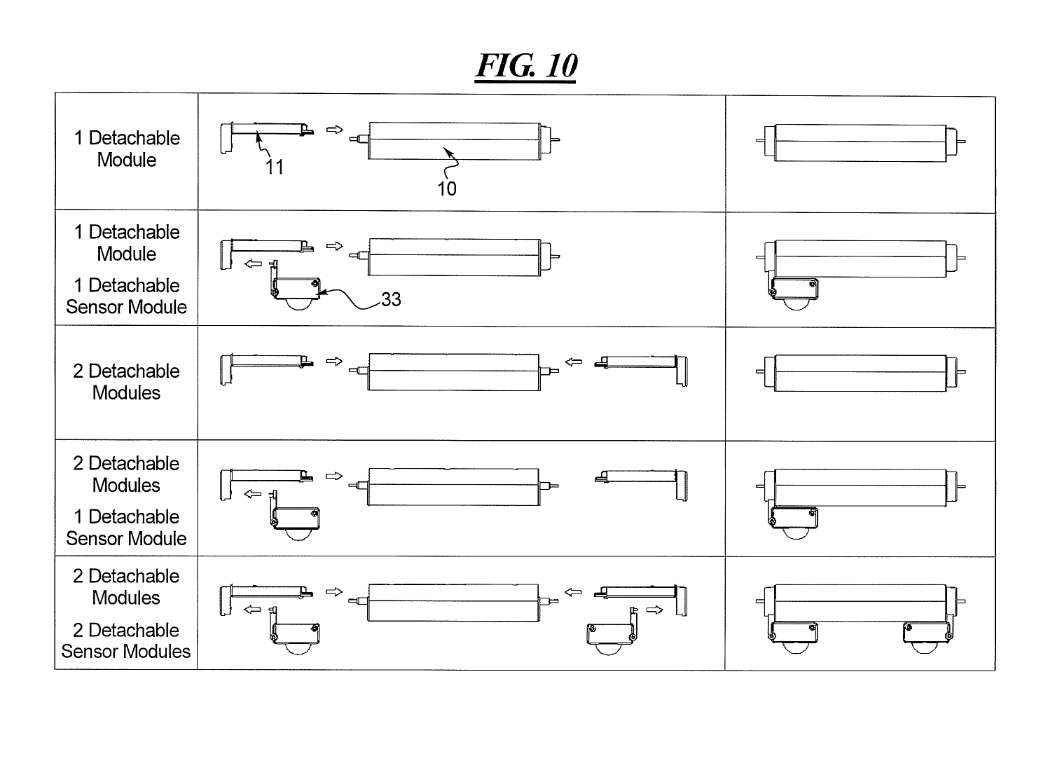

As shown in FIG. 10, one detachable module 11 may be provided at one end only of the lamp body 10 or two may be provided at opposite ends. Also the additional module 33 as a sensor additional module may also be provided in various configurations as illustrated in FIG. 10, including the use of two such additional sensor modules at opposite ends of the lamp body 10.

As shown in FIG. 11 the power supply unit 17 has an internal circuit 44 for feeding in the voltage on lines 21A and 21B from prongs 8A and 8B. This voltage may be AC or DC depending on the type of solid-state lighting retrofit lamp body employed and received in the known fluorescent fixture. The power supply circuitry on internal circuit 44 is thus adapted depending on whether AC or DC is supplied from the fluorescent fixture. The solid-state light module 45 is of known design and is powered by the internal circuit 44.

It should be further understood that although four prongs are shown as for a standard fluorescent lighting fixture, the present application applies to many other types of lamps such as electronic ballast lamps, magnetic ballast lamps, AC line voltage lamps, DC lamps, spherical-shaped bulb lamps, flat-surface radiating lamps, and many other types of lamps. These various types of lamps could have a variety of types of fixtures for receiving those lamps in a variety of types of connections to those lamps. However, it is to be understood that the power supply circuitry is to be adapted depending on whatever type of AC or DC power is fed to the various types of lamps. The power supply will output a first DC voltage V1+, V1− for the light module and a different DC voltage V2+, V2− for the detachable module as illustrated in FIG. 11. The design of such a power supply unit for the various types of input voltage and the two output voltages for the light module and the detachable module is well within the ability of those skilled in this art and therefore specific circuitry has not been shown for such various power supplies.

It should also be understood the term “fixture” as used through out this specification is intended to cover not only 2-4 prong receptacle fluorescent light fixtures, but also a screw end base, an E26 lamp base, and many other various types of lamp connectors or terminals depending on installation preference.

The power supply 17 has the output contact members 20A, 20B, and 20C as shown in FIG. 4 with 20A being V2+ with 20C being V2−, and with contact member 20B for control of the voltage fed to the light module 45 via the internal circuit 44. Preferably a different DC voltage V1+and V− is fed to the light module 45. The voltage V1−or V2− may preferably be 0 volts.

The design of the power supply has not been shown in detail since it is a conventional AC to DC power supply or DC to DC power supply. Also the control circuitry to dim or turn the light module on or off has not been shown since it is simply a variable DC voltage for dimming or a switch for turning the DC voltage to the lamp module on or off.

Although the power supply has been shown internal for the lamp tube application, it could be located externally in other applications.

FIG. 11 also shows the detachable module space 16 for receiving the detachable module 11 shown in FIG. 1. As also shown in FIG. 11 are the prongs 8C and 8D on the opposite end of the lamp body, which are not connected.

The light module 45 in FIG. 11 has at least one solid-state lighting device such as for example an LED, an OLED, or other solid-state lighting device. A control signal on contact member 20B is used to control the lamp of the light module 45 on, off, and for dimming the light intensity thereof.

As shown in FIG. 12 an additional set of contact members 49A, 49B, 49C may be located in another detachable module space 16A at an opposite end of the lamp body for receiving a further detachable module.

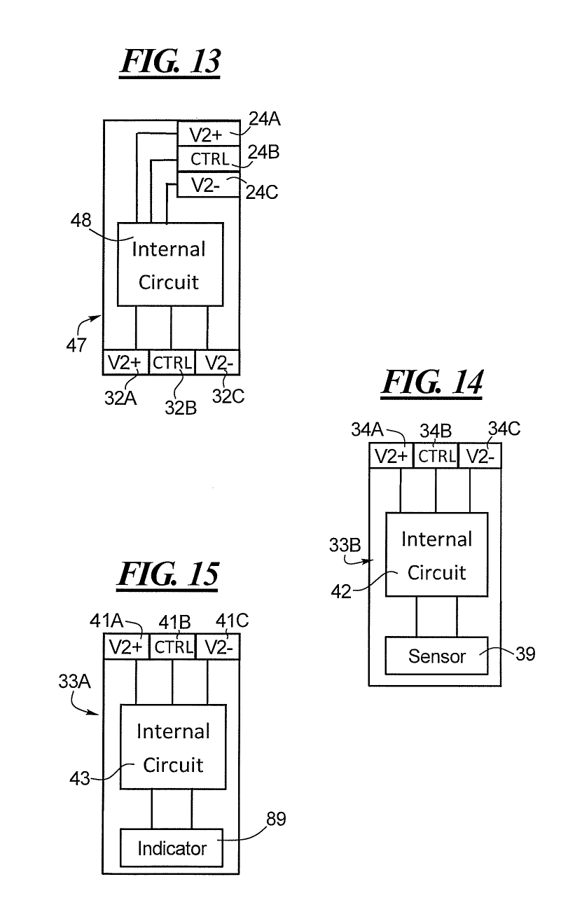

As shown in FIG. 13 the detachable module 11 has internal circuitry as shown at 47 with an internal circuit 48 as discussed previously in connection with FIG. 6 connecting to the terminals 24A, 24B, 24C previously shown in FIG. 6 at one end of the wireless module printed circuit board assembly 25. Contact members 32A, 32B, 32C are also shown at the opposite end of the PCB assembly 25 as also illustrated in FIG. 6.

The internal circuit 48 in FIG. 13 of the detachable module 33 may provide communication, control, detection, signal, alarm, media function, indication, and actuation for the lamp of the light module 45. The control contact member 24B can control the lamp on, off, and for dimming light intensity.

As shown in FIG. 14 a sensor 39 may be provided in a detachable module 33B for controlling lights in the light module 45.

As shown in FIG. 15 a sensor is not provided and the internal circuit 43 of the additional detachable module 33A functions as an indication module. Here an indicator 89 is connected to the internal circuit 43. The indicator may be a signaling LED, a speaker, a vibration unit, etc. Detachable module 33A as the indication module may be wirelessly controlled by another lighting apparatus with a sensor module 33B as shown in FIG. 14 and accompanying detachable module 11 (with wireless communication module within). The additional detachable module 33B is a sensor module which acquires surrounding environment information (sound, motion, smoke, vibration, light, temperature, etc.) via the previously mentioned sensor 39 shown in FIG. 14. The internal circuit 42 processes this information and a) control lighting module 45 (on/off, dimming, color changing, etc.), and/or b) sends the information to detachable module 11 (with wireless communication module within) which transmits the information wirelessly to the other lighting apparatus and hence controls the behavior of its lighting module and/or indication module 33A (on/off, dimming, color changing, etc.).

From the foregoing it may be appreciated that if one detachable module is provided then one additional detachable module may be connected to that respective detachable module. If another detachable module is provided then another additional detachable module may be coupled to the further detachable module.

FIG. 16 shows an alternate embodiment of the solid-state lighting apparatus with detachable module. In this alternate embodiment a lamp body 52 which has an extended end 52A receives a detachable module 53 and also receives at a bottom surface an additional module 54 such a sensor module. If no additional sensor module 54 is provided then a dummy cover 55 may be connected to the bottom surface of the extension 52A. FIG. 16 also shows other possible combinations of the lamp body with one or more detachable module 53 and one or more additional sensor modules 54, and also illustrates the use of additional dummy covers.

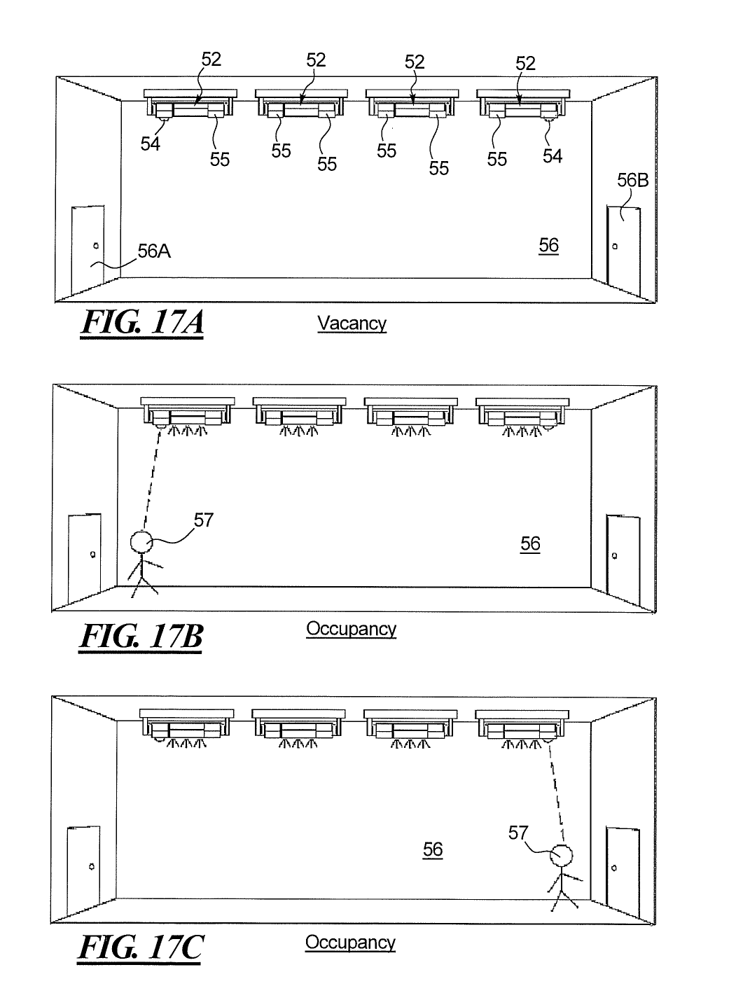

FIGS. 17A, 17B, and 17C illustrate occupancy detection of a person 57 entering a room 56 at the left side and existing at the right side. As one may observe the left most lamp body 52 has a respective sensor 54 and the right most lamp body 52 has a respective sensor 54, the respective sensors 54 being adjacent the respective doors 56A and 56B of the room 56. Thus as shown in FIG. 17B of the sensor 54 on the left most lamp body 52 senses presence of the person 57 entering through the door 56A and in FIG. 17C the right most lamp body 52 with its sensor 54 senses exit of the person 57 from the room through the opposite door 56B.

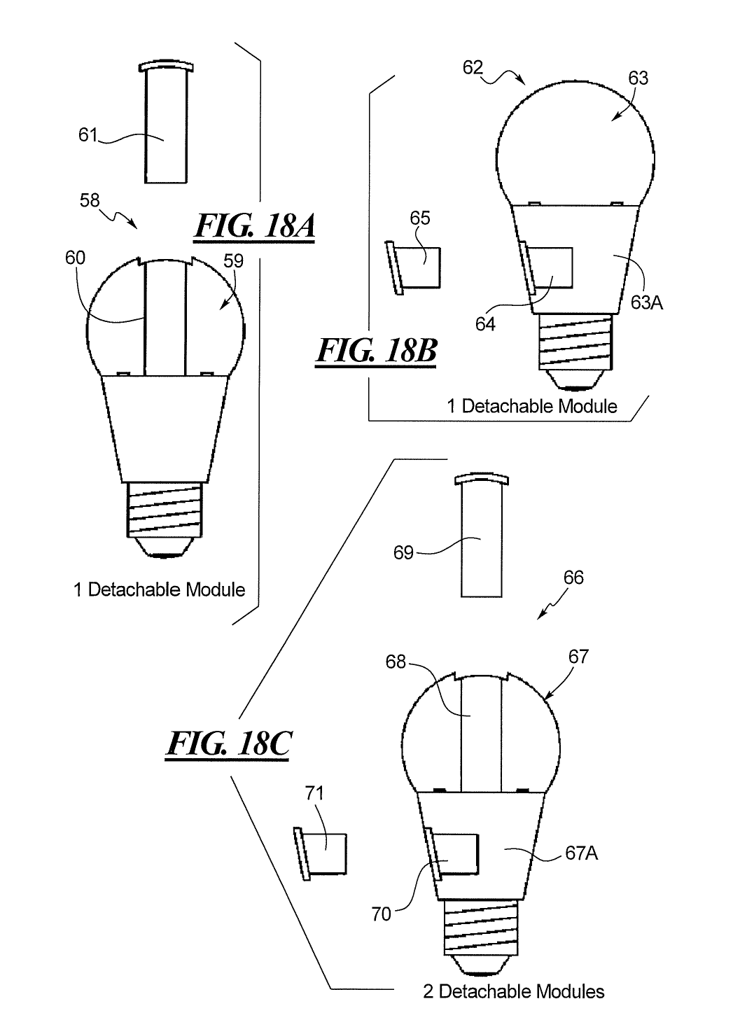

Another alternative embodiment of the solid-state lighting apparatus with detachable module is generally illustrated at 58 in FIG. 18A. Here a semi-spherical solid-state lighting bulb 59 is provided as a lamp body and having a detachable module space 60 located centrally therein and extending vertically. The module space 60 receives the detachable module 61.

In FIG. 18B in another alternate embodiment the solid-state lighting apparatus with detachable module system 62 employs a semi-spherical solid-state lighting bulb 63 having in a base portion 63A a detachable module space 64 for receiving a detachable module 65.

In FIG. 18C an alternate embodiment of the solid-state lighting apparatus with detachable module system is shown at 66 having a semi-spherical solid-state lighting bulb 67 having a first detachable module space 68 for receiving a first detachable module 69. A base portion 67A has a second detachable module space 70 for receiving a second detachable module 71.

In FIGS. 18A, 18B, and 18C, the detachable modules may also be coupled to an additional detachable module or modules as described in earlier drawing figures.

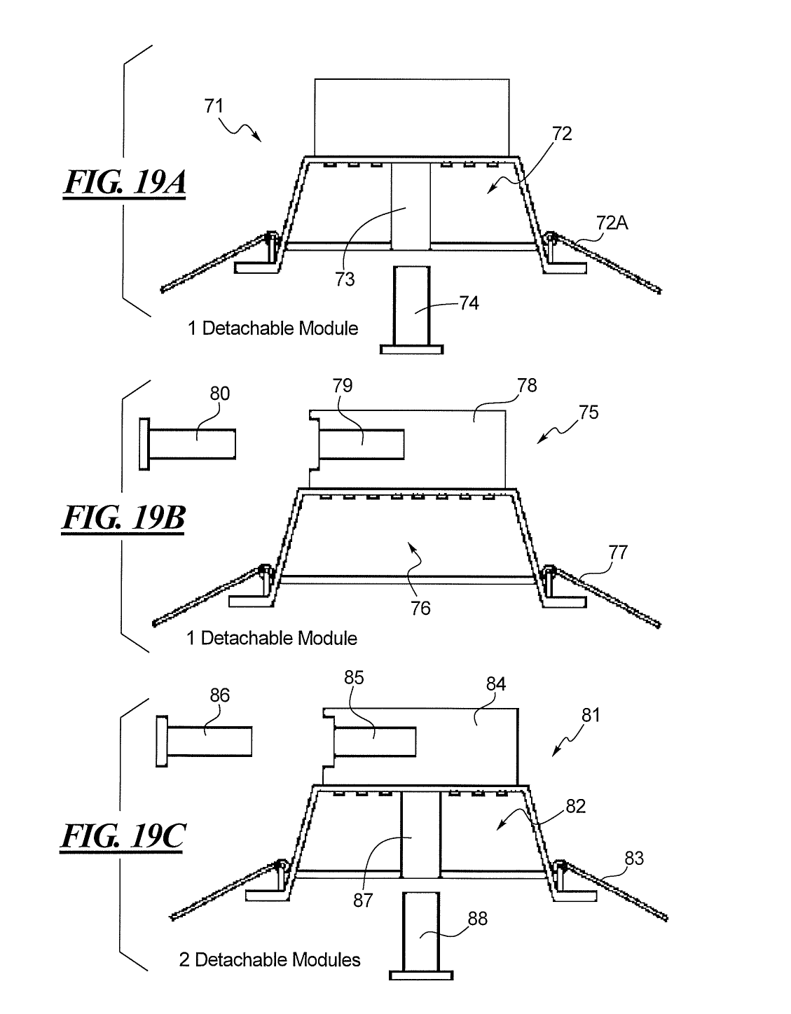

In FIG. 19A, another alternate embodiment is shown of a solid-state lighting apparatus with detachable module generally illustrated at 71 and having a lamp body 72 attached to fixture 72A and radiating light downwardly and a detachable module space 73 for receiving a detachable module 74 vertically oriented.

In FIG. 19B, another alternate embodiment of the solid-state lighting apparatus with detachable module is shown generally at 75 and having a downwardly facing lamp body 76 in a fixture 77 and a top portion 78 with a detachable module space 79 for receiving horizontally a detachable module 80.

FIG. 19C shows another alternate embodiment of a solid-state lighting apparatus with detachable module 81 having a downwardly facing lamp body 82 in a fixture 83 and radiating light downwardly. A top portion 84 has a first detachable module space 85 receiving a first detachable module 86 aligned horizontally and a second detachable module space 87 is provided in lamp body 82 receiving a second detachable module 88 aligned vertically.

In FIGS. 19A, 19B, and 19C, the detachable module in each case may be attached to an additional detachable module as described in previous drawing figures.

Although preferred exemplary embodiments are shown and described in detail in the drawings and in the preceding specification, they should be viewed as purely exemplary and not as limiting the invention. It is noted that only preferred exemplary embodiments are shown and described, and all variations and modifications that presently or in the future lie within the protective scope of the invention should be protected.

What is claimed is:

1. A solid-state lighting apparatus, comprising:
a lamp body with a solid-state light module and a detachable module space in said lamp body;
a detachable module exterior to said lamp body prior to insertion and insertable into said detachable module space and having contacts engageable with corresponding contacts in said module space;
said detachable module having an internal circuit for controlling said solid-state light module.

2. The apparatus of claim 1, wherein said lamp body has a power supply unit integrated therein and connectible to the detachable module in said detachable module space.

3. The apparatus of claim 2, wherein an interchangeable platform is provided and comprises said power supply unit, said power supply unit having said corresponding contacts which are engageable with said contacts of said detachable module.

4. The apparatus of claim 3, wherein said power supply unit has an internal circuit receiving electrical power based on an electrical supply to said lamp body and which supplies power to said light module.

5. The apparatus of claim 1, wherein said lamp body with said solid-state light module is a retrofit for a fluorescent lamp body and is receivable as said retrofit in a fluorescent lamp fixture for receiving said fluorescent lamp body.

6. The apparatus of claim 5, wherein said lamp body is tubular-shaped and has two prongs at one end and two prongs at an opposite end, said prongs being arranged so that said lamp body is said retrofit for said fluorescent lamp body received in said fluorescent lamp fixture.

7. The apparatus of claim 1, wherein said detachable module performs at least one of the functions of wireless communication, optical communication, actuation of the light module, sensor activation of the light module, activation of the light module based on received light, control of the light module based on motion detection, control of the light module based on smoke detection, control of the light module based on temperature detection, control of the light module based on received sound, and control of the light module based on user activation.

8. The apparatus of claim 1, wherein said contacts of the detachable module and the corresponding contacts at said module space comprise at least one contact for voltage and another contact for a control signal.

9. The apparatus of claim 8, wherein a second contact is provided for voltage.

10. The apparatus of claim 1, wherein first and second detachable module spaces are provided for receiving the detachable module or a further detachable module.

11. The apparatus of claim 1, wherein a further detachable module is provided and wherein the detachable module is receivable in a first detachable module space and the second detachable module is received in a second detachable module space.

12. The apparatus of claim 1, wherein the lamp body is shaped as a tube and said detachable module space is at one end of said tube.

13. The apparatus of claim 1, wherein said detachable module has additional contacts, and an additional detachable module is provided having contacts engageable with said additional contacts of said detachable module.

14. The apparatus of claim 13, wherein said additional detachable module comprises a sensor module having a sensor.

15. The apparatus of claim 13, wherein said additional detachable module comprises an indication module.

16. The apparatus of claim 1, wherein said lamp body comprises a partially spherical bulb.

17. The apparatus of claim 1, wherein said lamp body comprises a body with parallel flat sides and light emitting from one of said sides.

18. The apparatus of claim 1, wherein said lamp body is tubular and has a curved optical portion and a curved opaque portion opposite the optical portion and wherein an LED printed circuit board assembly is provided with LEDs on one surface positioned to radiate light through said optical portion.

19. A solid-state lighting apparatus, comprising:
a lamp body with a solid-state light module and a detachable module space in said lamp body;
a detachable module exterior to said lamp body prior to insertion and insertable into said detachable module space and having contacts engageable with corresponding contacts in said module space;
said detachable module having an internal circuit for controlling said solid-state light module; and
an additional detachable module connectible to said detachable module.

20. A solid-state lighting apparatus, comprising:
a lamp body with a solid-state light module and a detachable module space in said lamp body;
a detachable module exterior to said lamp body prior to insertion and insertable into said detachable module space and having contacts engageable with corresponding contacts in said module space;
said detachable module having an internal circuit for controlling said solid-state light module; and
said lamp body being a retrofit for a fluorescent light module and receivable as said retrofit into a fixture for receiving said fluorescent light module.

21. The solid-state lighting apparatus of claim 1, 19, or 20, wherein said lamp body functioning with said detachable module.

22. The solid-state lighting apparatus of claim 1, 19, or 20, wherein said lamp body functioning without said detachable module.
